(19) United States
(12) Patent Application Publication
(10) Pub. No.: US 2026/0261042 A1
(43) Pub. Date: Sep. 3, 2026

(54) ANTENNA ARRAY SYSTEM

(71) Applicant: Asia Eastern University of Science and Technology, New Taipei City (TW)

(72) Inventors: CHENG-NAN HU, TAOYUAN CITY (TW); KUANG-CHUNG CHOU, TAIPEI CITY (TW)

(21) Appl. No.: 19/068,001

(22) Filed: Mar. 3, 2025

(51) Int. Cl. H01Q 3/36; H01Q 9/04; H01Q 19/10

(52) U.S. Cl. CPC H01Q 3/36; H01Q 9/0407; H01Q 19/10

(57) ABSTRACT

An antenna array system is provided. The antenna array system includes a plurality of reflector arrays and a controller. Each of the reflector arrays includes a carrier, and a plurality of antenna units and a plurality of liquid crystal phase shifters that are disposed on the carrier. The liquid crystal phase shifters are electrically coupled to the feeding circuits of antenna units and are configured to control phases of the antenna units. The controller is detachably and electrically coupled to the reflector arrays. The controller includes a processor and a command distributor electrically coupled to the processor, the command distributor is configured to send signals that are processed by the processor and originate from at least one of SPI and GPIO to the antenna, so as to control each of the bias states to liquid crystal at an ON or an OFF state.

### FIELD OF THE DISCLOSURE

The present disclosure relates to a system, and more particularly to an antenna array system.

### BACKGROUND OF THE DISCLOSURE

In 5G, 5G-A, and 6G wireless communication applications, the balancing issue between downlink and uplink (DL-UL) has become particularly problematic. Moreover, in the millimeter-wave frequency bands, communication links frequently face severe propagation attenuation challenges, especially in urban environments. This is primarily due to building penetration losses under non-line-of-sight (NLOS) conditions, leading to increased diffraction and reflection losses.

The Reconfigurable Intelligent Surface (RIS) technology has emerged to address these challenges. RIS consists of an array of reflectors capable of controlling the phase and amplitude of individual received signals. This control allows for channel optimization by directing radiated signals in predetermined directions. RIS technology shows promise in solving issues under NLOS scenarios in both indoor and outdoor urban areas.

However, due to the fact that RIS can operate as a transmitter, a receiver, or a reflector, each scenario brings its own control challenges. Meanwhile, the complexity of RF millimeter-wave devices involved in RIS control circuit design makes the cost of RIS design expensive.

### SUMMARY OF THE DISCLOSURE

In response to the above-referenced technical inadequacy, the present disclosure provides an antenna array system with each antenna integrated with a liquid crystal phase shifter.

In order to solve the above-mentioned problems, one of the technical aspects adopted by the present disclosure is to provide an antenna array system. The antenna array system includes a plurality of reflector arrays and a controller. Each of the reflector arrays includes a carrier, and a plurality of antenna units and a plurality of liquid crystal phase shifters that are disposed on the carrier. The liquid crystal phase shifters are electrically coupled to a plurality of feeding circuits of the antenna units and are configured to control phases of the antenna units. The controller is detachably and electrically coupled to the reflector arrays. The controller includes a processor and a command distributor electrically coupled to the processor, the command distributor is configured to send signals that are processed by the processor and originate from at least one of serial peripheral interface (SPI) and general-purpose input/output (GPIO) to the antenna, so as to control a bias state of each of the liquid crystal phase shifters to switch between an ON state and an OFF state.

Therefore, in the antenna array system provided by the present disclosure, by virtue of “the liquid crystal phase shifters being electrically coupled to the feeding circuits of the antenna units and being configured to control phases of the antenna units,” and “the command distributor being configured to send signals that are processed by the processor and originate from at least one of SPI and GPIO to the antenna units, so as to control a bias state of each of the liquid crystal phase shifters to switch between an ON state and an OFF state,” the antenna array system can be established the optimal phase distribution for adapting the operation scenarios. Therefore a good linking quality of reflection and reception signals of any one of the reflector arrays through the controller according to environmental conditions, and the controller can be removed and used to adjust the reflector arrays in another area.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a circuit block of an antenna array system according to one of the embodiments of the present disclosure; and

FIG. 2 is a planar view of a reflector array according to one of the embodiments of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

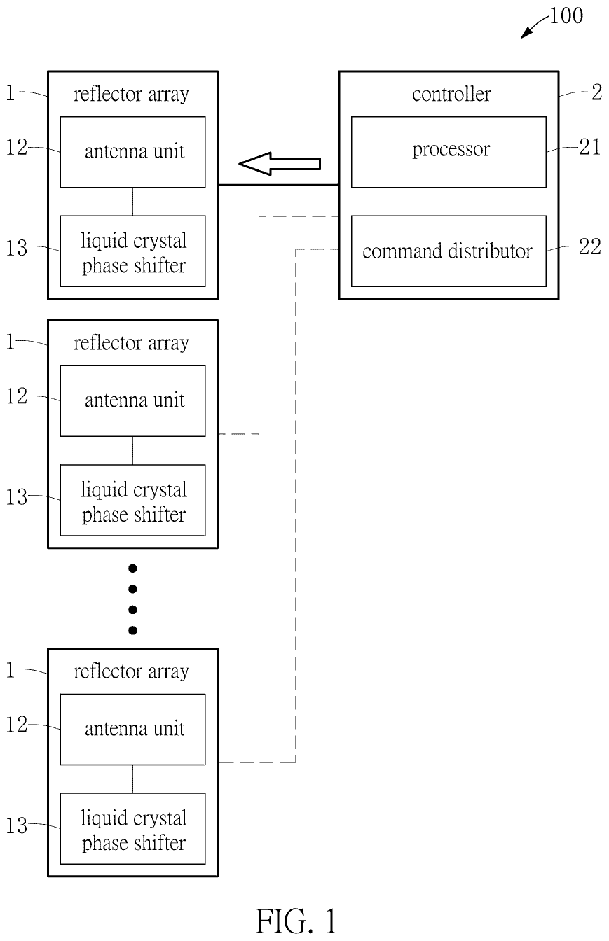

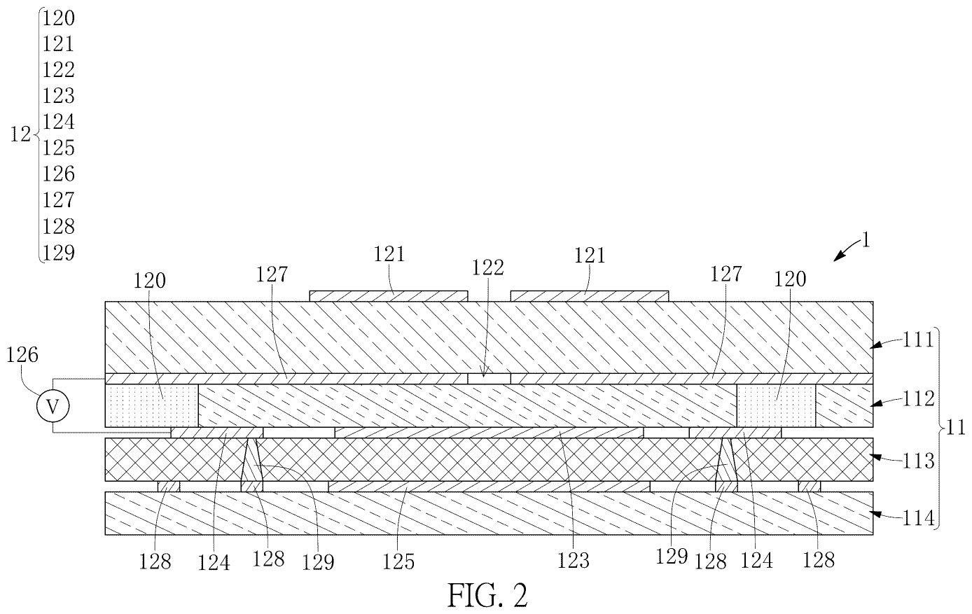

Referring to FIG. 1 and FIG. 2, the present disclosure provides an antenna array system 100. The antenna array system 100 includes a plurality of reflector arrays 1 and a controller 2 that is detachably and electrically coupled to the reflector arrays 1. In practical applications, the reflector arrays 1 can be installed in various environments (e.g., exterior walls of buildings, and interior walls). The controller 2 can be selectively connected to any one of the reflector arrays 1, and the controller 2 can analyze the most suitable reflection configuration based on the environmental conditions of each of the reflector arrays, so as to adjust each of the reflector arrays 1.

In other words, the controller 2 with computational capabilities and higher cost can be carried to different environments as needed to work with different reflector arrays, thereby saving costs while optimizing the reflector arrays under various conditions. The following description describes the structure and connection relation of each component of the antenna array system 100.

Referring to FIG. 1 and FIG. 2, the reflector arrays 1 can jointly form a planar structure. The reflector arrays 1 can dynamically adjust electromagnetic properties, so as to control the reflection, refraction, focusing, and other behaviors of incident wireless signals. Accordingly, through intelligent control of the reflector arrays, the wireless communication environment can be reshaped to optimize signal linking quality.

Specifically, each of the reflector arrays 1 includes a carrier 11, and a plurality of antenna units 12 and a plurality of liquid crystal phase shifters 13 that are disposed on the carrier 11. The liquid crystal phase shifters 13 are electrically coupled to a plurality of feeding circuits of the antenna units 12 and are configured to control phases of the antenna units 12. In practice, each of the liquid crystal phase shifters is open-ended strip-line on a liquid crystal layer 112 of the carrier 11 employed to produce the 180 degrees phase difference by the controller 2 through switching the bias voltage on an electrode 124 of each of the antenna units 12 between an ON state or an OFF state, so as to realize a function of a 1-bit phase shifter.

In one embodiment, the reflector arrays can jointly form a window structure, so as to be installed in a building. In detail, the carrier 11 includes a upper glass layer 111, a liquid crystal layer 112, a driver layer 113, and a lower glass layer 114 to carry the driver layer 113 The liquid crystal layer 112 is disposed between the upper glass layer 111 and the driver layer 113, so that a control signal can distribute the bias voltage level on electrode of the liquid crystal layer 112 for producing the 180 degree phase difference by switching from “OFF” to “ON” state. Preferably, the driver layer 113 can utilize TFT (Thin-Film Transistor) process technology to implement the signal grounding traces and a plurality of bias circuit routing traces of a bias voltage element of each of the antenna units. Additionally, photosensitive polyimide (PSPI), which is a buffering coating showing low dielectric properties, serves as the driver layer 113 and allows blind via connections between a mesh ground 127 of each of the antenna units 12 and a ground strip-line 125 of each of the antenna units 12.

In other words, the driver layer 113 is PSPI that is configured to be used to connect the mesh ground 127 and a plurality of signal traces of the controller 2 through a plurality of blind vias 129 of the carrier 11.

In practice, a cavity is established between the upper glass layer 111 and the driver layer 113 through spacers 120, and liquid crystal is injected into the cavity and sealed to form the liquid crystal layer 112.

Furthermore, each of the antenna units 12 also includes two patch antennas 121, a slot-line 122, an open-ended strip-line 123, an electrode 124, a controlling signal trace 128, the ground strip-line 125, the mesh ground 127, and a bias voltage element 126. The controlling signal trace 128 and the ground strip-line 125 are arranged between the driver layer 113 and the lower glass layer 114, and the controlling signal trace 128 can be routed on the driver layer 113 or the lower glass layer 114 to deliver the bias signal on the electrode 124 of each of the antenna units 12 through via holes in the driver layer 113. The two patch antennas 121 are disposed on a surface of the upper glass layer 111. The slot-line 122 is located between the upper glass layer 111 and the liquid crystal layer 112. The open-ended strip-line 123 and the electrode 124 are located between the liquid crystal layer 112 and the driver layer 113. The ground strip-line 125 and the mesh ground 127 are disposed on a bottom surface of the upper glass layer 111 and a bottom surface of the driver layer 113, respectively.

In other words, the slot-line 122 is disposed on bottom surface of the upper glass layer 111, and the open-ended strip-line 123 working as a phase strip-line is disposed on top surface of the driver layer 113. Moreover, the two patch antennas 121 are disposed on one of two opposite outer sides of the carrier 11, and the ground strip-line 125 is disposed between another one of the two opposite outer sides of the carrier 11 and the lower glass layer 114.

The bias voltage element 126 is electrically coupled to the electrode 124 and the slot-line 122. Accordingly, when the bias voltage element 126 applies voltage, a switching from horizontal to vertical electric field is generated in the liquid crystal layer 112 resulting in a change in a dielectric constant of the liquid crystal layer 112. Therefore, the open ended strip-line with properly chosen length will introduce the 180 phase different between ON and OFF bias conditions.

In practice, when the voltage increases from 0 to a predetermined value, a phase difference between the two patch antennas is 180 degrees.

In other words, the reflector arrays 1 can modify the dielectric constant and control the phase (or beam direction) by simply adjusting the bias. Therefore, the reflector arrays 1 can be used as windows while meeting the requirements for visual and signal optimization.

It is worth noting that the bias voltage element 126 is responsible for providing voltage to the electrode and the slot-line 122 without consuming current, thereby saving energy consumption. Furthermore, each of the reflector arrays 1 does not use via holes, so as to be suitable for use as a window.

In a practical example, each of the reflector arrays can utilize an array composed of 1024 trimmed rectangular patch antennas printed on RF substrate using glass or FR4, so as to effectively reduce costs, but the present disclosure is not limited thereto. For instance, the electromagnetic surface design of each of the reflector arrays can also adopt trimmed circular patch antennas.

For mass production of reflector arrays, each patch antenna is manufactured with an open-circuit load in the PCB or thin-film process. To mitigate fading effects caused by multiple reflections, circularly polarized antennas can generate vertical and horizontal polarized fields. Therefore, it is recommended to use diamond-shaped patch antennas or circularly polarized antennas for the electromagnetic surface design of the patch antennas.

Referring to FIG. 1 to FIG. 2, the controller 2 in the present embodiment includes a processor 21 and a command distributor 22 electrically coupled to the processor 21, the command distributor 22 is configured to send signals that are processed by the processor 21 and originate from at least one of serial peripheral interface (SPI) and general-purpose input/output (GPIO) to the antenna units 12, so as to control each of the liquid crystal layer 13 to switch between an ON state and an OFF state.

Preferably, the processor 21 is configured to adaptively control the ON state and the OFF state of each of the liquid crystal phase shifter 13 by artificial intelligence (AI) or machine learning algorithms.

In practical applications, since obstacles in the line-of-sight (LOS) area between Node B and User Equipment (UE) affect the signal, the processor 21 can reconfigure the channel through AI algorithms to create alternative radio links at a reflection angle between Node B and UE. In other words, the processor 21 can iteratively control the bias state of the liquid crystal phase shifter 13 until the optimal signal quality of the radio link is achieved.

It is worth noting that frequently operating the liquid crystal phase shifter 13 (e.g., hundreds of liquid crystal phase shifters 13) to implement passive reconfigurable intelligent surface (RIS) at millimeter-wave frequencies is quite costly. Therefore, the controller 2 of the present disclosure can calculate the optimal signal layout to reconfigure the channel through AI algorithms, so as to determine the optimal bias state of the liquid crystal phase shifters 13 for each of the reflector arrays 1 in terms of loading effects (e.g., short circuit or open circuit). Consequently, once the reflector arrays 1 are controlled by the controller to achieve the optimal signal layout, the controller 2 can be removed (i.e., the reflector arrays 1 become pure electromagnetic surfaces), thus realizing a low-cost electromagnetic surface adaptable to various operational channel scenarios.

### Beneficial Effects of the Embodiment

Therefore, in the antenna array system provided by the present disclosure, by virtue of “the liquid crystal phase shifters being electrically coupled to the feeding circuits of the antenna units and being configured to control phases of the antenna units,” and “the command distributor being configured to send signals that are processed by the processor and originate from at least one of SPI and GPIO to the antenna units, so as to control a bias state of each of the liquid crystal phase shifters to switch between an ON state and an OFF state,” the antenna array system can be established the optimal phase distribution for adapting the operation scenarios. Therefore, a good linking quality of reflection and reception signals of any one of the reflector arrays through the controller according to environmental conditions, and the controller can be removed and used to adjust the reflector arrays in another area.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A antenna array system, comprising:
a plurality of reflector arrays, wherein each of the reflector arrays includes a carrier, and a plurality of antenna units and a plurality of liquid crystal phase shifters that are disposed on the carrier, wherein the liquid crystal phase shifters are electrically coupled to a plurality of feeding circuits of the antenna units and are configured to control phases of the antenna units; and
a controller detachably and electrically coupled to the reflector arrays, wherein the controller includes a processor and a command distributor electrically coupled to the processor, the command distributor is configured to send signals that are processed by the processor and originate from at least one of serial peripheral interface (SPI) and general-purpose input/output (GPIO) to the antenna units, so as to control a bias state of each of the liquid crystal phase shifters to switch between an ON state and an OFF state.

2. The antenna array system according to claim 1, wherein the carrier includes a upper glass layer, a liquid crystal layer, a driver layer, and a lower glass layer; wherein the liquid crystal layer is disposed between the upper glass layer and the driver layer, so that a control signal is configured to be distributed a bias voltage to an electrode of each of the antenna units for introducing the 180 degree phase difference under the ON state and the OFF state.

3. The antenna array system according to claim 2, wherein the driver layer is configured to utilize Thin-Film Transistor (TFT) process technology to implement a plurality of signal grounding traces and a plurality of bias circuit routing traces of a bias voltage element of each of the antenna units.

4. The antenna array system according to claim 2, wherein the driver layer is a photosensitive polyimide (PSPI) that is configured to be used to connect the mesh ground and a plurality of signal traces of the controller through a plurality of blind vias of the carrier.

5. The antenna array system according to claim 2, wherein each of the antenna units includes:
two patch antennas disposed on a surface of the upper glass layer away from the composite layer;
a slot-line located between the upper glass layer and the liquid crystal layer;
an open-ended strip-line and an electrode located between the liquid crystal layer and the composite layer;
a ground strip-line disposed on a surface of the composite layer away from the upper glass layer;
a bias voltage element electrically coupled to the electrode and the slot-line, wherein the bias voltage element is configured to apply voltage to the electrode and the slot-line; wherein, when the bias voltage element applies voltage, a vertical electric field is generated between the electrode and the slot-line, so that a change in a dielectric constant of the liquid crystal layer alters resonant frequencies of the two patch antennas.

6. The antenna array system according to claim 4, wherein, when the voltage increases from 0 to a predetermined value, a phase difference between the two patch antennas is 180 degrees.

7. The antenna array system according to claim 1, wherein the processor is configured to adaptively control the ON state and the OFF state of each of the liquid crystal phase shifter by artificial intelligence or machine learning algorithms.
